(19) United States
(12) Patent Application Publication
(10) Pub. No.: US 2011/0073321 A1
(43) Pub. Date: Mar. 31, 2011

(54) TUBULAR ACTUATOR AND METHOD

(75) Inventors: Peter J. Fay, Houston, TX (US); Darin H. Duphorne, Houston, TX (US)

(73) Assignee: BAKER HUGHES INCORPORATED, Houston, TX (US)

(21) Appl. No.: 12/567,013

(22) Filed: Sep. 25, 2009

(51) Int. Cl. E21B 34/14; F16L 55/11; F16K 31/00; F16K 31/12; F16K 1/42; E21B 34/06; E21B 23/00; E21B 33/12

(52) U.S. Cl. 166/373; 137/613; 251/49; 251/359; 166/194

(57) ABSTRACT

A tubular actuator includes, a tubular, a support member disposed at the tubular, and a restrictor configured to pass a runnable member when unsupported by the support member and to prevent passage of the runnable member when supported by the support member. The restrictor is movable relative to the support member from an unsupported position to a supported position in response to pressure applied against the runnable member engaged with the restrictor according to a pressure versus time profile.

### BACKGROUND

In industries concerned with earth formation boreholes, such as hydrocarbon recovery and gas sequestration, for example, it is not uncommon for various operations to utilize a temporary or permanent plugging device. Sometimes plugging is desirable at a first location, and subsequently at a second location. Moreover, additional plugging locations may also be desired and the plugging can be sequential for the locations or otherwise. Systems employing droppable members, such as balls, for example, are typically used for just such a purpose. The ball is dropped to a ball seat positioned at the desired location within the borehole thereby creating the desired plug.

In applications where the first location is further from surface than the second location, it is common to employ seats with sequentially smaller diameters at locations further from the surface. Dropping balls having sequentially larger diameters allows the ball seat furthest from surface to be plugged first (by a ball whose diameter is complementary to that seat), followed by the ball seat second furthest from surface (by a ball whose diameter is complementary to that seat) and so on.

The foregoing system, however, creates increasingly restrictive dimensions within the borehole that can negatively impact flow therethrough as well as limit the size of tools that can be run into the borehole. Systems and methods that allow operators to plug boreholes at multiple locations without the drawbacks mentioned would be well received in the art.

### BRIEF DESCRIPTION

Disclosed herein is a tubular actuator. The tubular actuator includes, a tubular, a support member disposed at the tubular, and a restrictor configured to pass a runnable member when unsupported by the support member and to prevent passage of the runnable member when supported by the support member. The restrictor is movable relative to the support member from an unsupported position to a supported position in response to pressure applied against the runnable member engaged with the restrictor according to a pressure versus time profile.

Further disclosed herein is a method of selectively actuating a tubular actuator. The method includes, running a runnable member within a tubular, engaging a restrictor disposed at the tubular with the runnable member, and doing one of the following. Pressuring up against the engaged runnable member to pressure exceeding a threshold pressure before expiration of a selected period of time and passing the runnable member past the restrictor. Or pressuring up against the engaged runnable member to pressure equal to or less than the threshold pressure for at least the selected period of time thereby moving the restrictor to a supported position and preventing passage of the runnable member.

Further disclosed herein is a tubular actuator. The tubular actuator includes, a restrictor positionable within a tubular relative to a support member between an unsupported position where passage of a runnable member is facilitated, and a supported position where passage of the runnable member is prevented.

### BRIEF DESCRIPTION OF THE DRAWINGS

The following descriptions should not be considered limiting in any way. With reference to the accompanying drawings, like elements are numbered alike:

FIG. 1 depicts a cross sectional view of a tubular actuator disclosed herein in a run in position;

FIG. 2 depicts a cross sectional view of the tubular actuator of FIG. 1 in a position that allows passage of a runnable member;

FIG. 3 depicts a cross sectional view of the tubular actuator of FIG. 1 in an actuated position;

FIG. 4 depicts a cross sectional view of the tubular actuator of FIG. 1 in an actuated position with the seat in a defeatable position having passed a runnable member therethrough;

FIG. 5 depicts a cross sectional view of an alternate tubular actuator disclosed herein in a position passable of a runnable member;

FIG. 6 depicts a cross sectional view of the tubular actuator of FIG. 5 in a position with a runnable member seated thereat;

FIG. 7 depicts a cross sectional view of the tubular actuator of FIG. 5 in a position wherein the seat is supported;

FIG. 8 depicts a cross sectional view of the tubular actuator of FIG. 5 in an actuated position;

FIG. 9 depicts a cross sectional view of the tubular actuator of FIG. 5 in a position where the sleeve has reset relative to the body;

FIG. 10 depicts a partial cross sectional view of an alternate embodiment of a tubular actuator disclosed herein in a position wherein a runnable member is seated thereon;

FIG. 11 depicts a partial cross sectional view of the tubular actuator of FIG. 10 in a defeatable position about to pass a runnable member thereby; and

FIG. 12 depicts a partial cross sectional view of the tubular actuator of FIG. 10 in a position with the runnable member seated and the seat being supported.

### DETAILED DESCRIPTION

A detailed description of one or more embodiments of the disclosed apparatus and method are presented herein by way of exemplification and not limitation with reference to the Figures.

Embodiments of a tubular actuator disclosed herein allow an operator to selectively actuate or selectively pass each of one or more of the tubular actuators disposed within a tubular. The operator runs a runnable member to engage with the tubular actuator(s) and then either pressures up to above a latch pressure to perform an actuation process or to below the latch pressure to allow the runnable member to pass through the tubular actuator thereby avoiding performance of an actuation.

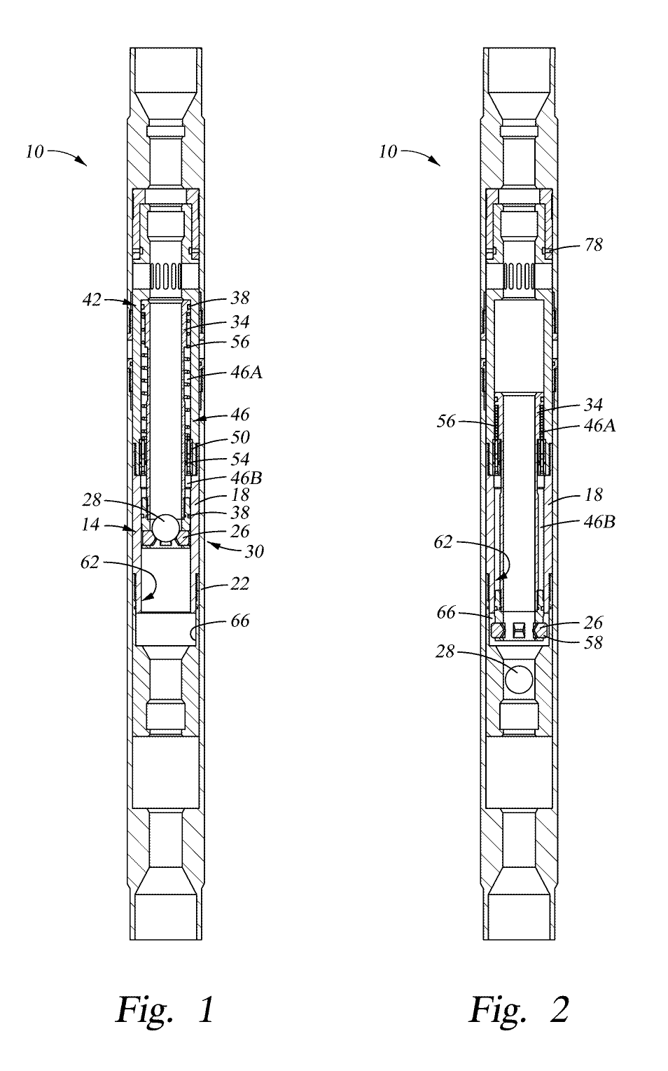

Referring to FIG. 1, an embodiment of the tubular actuator disclosed herein is illustrated generally at 10. The tubular actuator 10 includes, a restrictor 14 having a body 18, which is movable within a tubular 22 during actuation, and a seat 26 that is sealingly engagably receptive of a runnable member 28, illustrated herein as a ball. The seat 26 is selectively defeatable such that the ball 28 is able to pass as will be explained in detail below. The seat 26 in this embodiment is attached to an end 30 of a sleeve 34. The sleeve 34 is slidably sealingly engaged with the body 18 by seals 38, illustrated herein as o-rings, at both the end 30 and an opposing end 42 thereby creating a chamber 46, defined by the annular space between the body 18 and the sleeve 34 and bound at the ends 30, 42 by the two o-rings 38, that is fluidically isolated. The chamber 46 is divided into two sub-chambers 46A and 46B by a shoulder 50 extending from the body 18 and slidably sealingly engaged with the sleeve 34. One or more ports 54 in the shoulder 50 fluidically connect the sub-chambers 46A and 46B to one another. As such, movement of the sleeve 34 relative to the body 18 causes fluid, such as hydraulic oil, for example, housed within the chamber 46 to be pumped from one of the sub-chambers 46A, 46B to the other of the sub-chambers 46A, 46B through the port(s) 54. The foregoing structure allows an operator to control a time for the sleeve 34 to move through a full stroke by adjustment of the size and number of the port(s) 54 used. Regardless of whether the sleeve 34 has been fully stroked, a reduction in pressure can allow the sleeve 34 to move back to its original position under the influence of a biasing member 56, illustrated herein as a compression spring, compressingly engaged between the sleeve 34 and the body 18.

Referring to FIG. 2, the seat 26 becomes defeatable once the sleeve 34 has fully stroked relative to the body 18. In this embodiment the seat 26 includes a plurality of seat sections 58 that are radially expandable to allow passage of the ball 28 when the seat sections 58 are not supported by an inner radial surface 62 of the body 18. Since the seat sections 58 are radially supported by the inner radial surface 62 at all relative locations of the sleeve 34 and body 18 other than the fully stroked position (wherein the seat sections 58 are able to move into an inner recess 66), it is only when the sleeve 34 is in the fully stroked position, as illustrated in FIG. 2, that the ball 28 is allowed to pass. Moving the sleeve 34 to the fully stroked position can be done by applying pressure to a ball 28 seated against the seat 26, thereby urging the sleeve 34 to move.

Movement of the sleeve 34 relative to the body 18, however, is prevented if pressure applied to the seated ball 28 exceeds a latch pressure defined as the pressure at which latching occurs between the sleeve 34, (or the seat 26 itself) and the body 18. This latching can be through an increase in frictional engagement between the sleeve 34, the seat 26, or both, and the inner radial surface 62 of the body 18 for example. Alternate latching engagement mechanisms are contemplated but not disclosed in further detail herein.

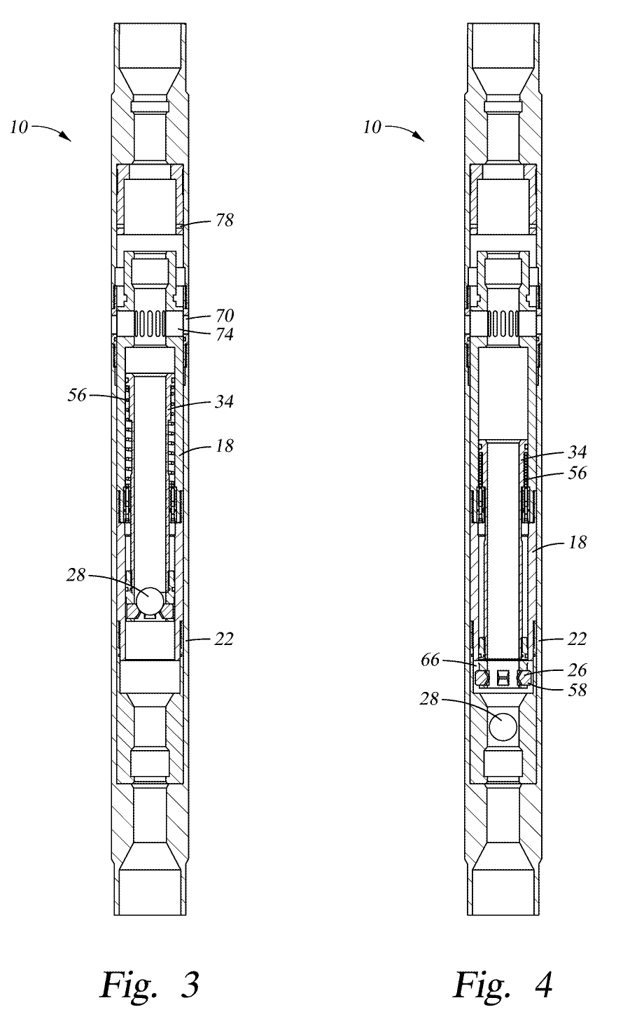

Referring to FIG. 3, when pressure exceeding the latch pressure is supplied prior to the sleeve 34 completing a full stroke, the sleeve 34 becomes longitudinally fixed relative to the body 18. Once the sleeve 34 is latched to the body 18, all of the forces generated by pressure against the seated ball 28 are transferred through the body 18 to the tubular 22. This force can be used to move the body 18 relative to the tubular 22 in an actuating event. For example, the body 18 may block one or more ports 70 in the tubular 22 while in its original position (FIGS. 1 and 2), and then effectively open the port(s) 70 by aligning them with one or more ports 74 in the body 18 after the body 18 has moved (FIGS. 3 and 4). Such an actuation can be used to provide selective access to a formation outside the tubular 22 for fracturing, for example, in a downhole hydrocarbon or sequestration application. Additionally, one or more releasable members 78, shown herein as shear screws, may longitudinally attach the body 18 to the tubular 22 until a selectable load, such as by a threshold pressure, is applied therebetween, to prevent inadvertent actuation of the tubular actuator 10.

Referring to FIG. 4, the ball 28 may still be allowed to pass after the tubular actuator 10 has been actuated. To do so, one would simply reduce the pressure after the actuation is completed to pressure below the latch pressure. In so doing the sleeve 34 becomes unlatched from the body 18 and permits the sleeve 34 to move relative to the body 18. After full stroking of the sleeve 34 has occurred the seat sections 58 can expand radially into the inner recess 66 and allow the ball 28 to pass therethrough, as is illustrated in FIG. 4. After passage of the ball 28 the biasing member 56 can return the sleeve 34 to its original position with respect to the body 18, thereby being reset to a position engagable by another of the balls 28.

Positioning a plurality of the tubular actuators 10 along the tubular 22 allows an operator to selectively actuate any one of the plurality of actuators 10 regardless of the number of actuators 10 between it and the origin of entry for the balls 28.

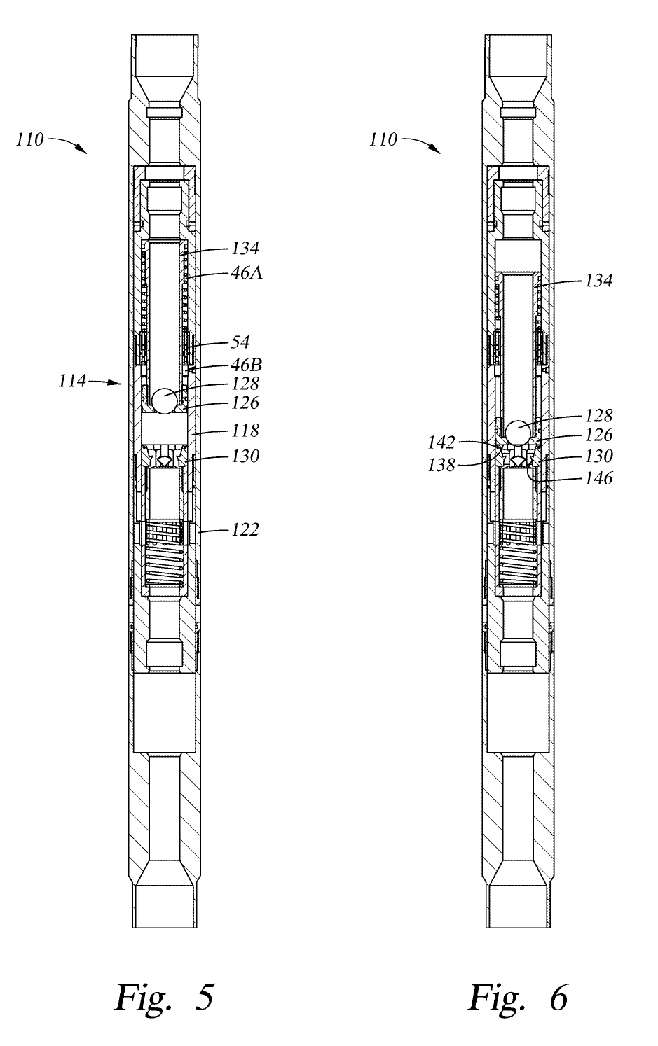

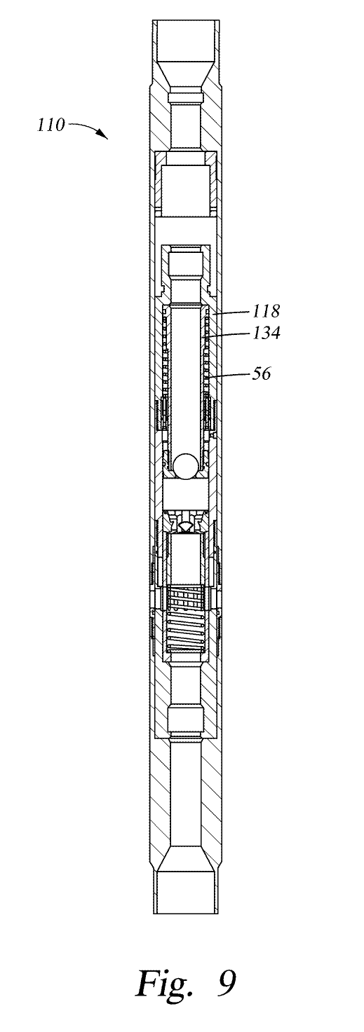

Referring to FIGS. 5-9, an alternate embodiment of a tubular actuator disclosed herein is illustrated generally at 110. The tubular actuator 110 includes, a restrictor 114 having a body 118, which is movable within a tubular 122, and at least one support member 130, with multiple support members 130 being illustrated in this embodiment. The restrictor 114 also has a seat 126 that is sealingly engagably receptive to a runnable member 128, illustrated herein as an extrudable ball. The seat 126 is attached to an end of a sleeve 134 and is movable within the body 118. The actuator 110 is similar to the actuator 10 in that chambers 46A and 46B are fluidically connected to each other by port(s) 54 that control a rate at which fluid is able to flow between the two chambers 46A and 46B. This rate of fluid flow controls a rate of movement of the sleeve 134 with respect to the body 118. Unlike the actuator 10, however, wherein passage of the runnable member 28 was prevented until the sleeve 34 had been fully stroked, in the actuator 110 the runnable member 128 is only allowed to pass the restrictor 114 prior to full stroking of the sleeve 34. This passage is due to extrusion of the runnable member 128 by the seat 126 if pressure exceeding a threshold pressure is applied thereagainst prior to repositioning of the support members 130.

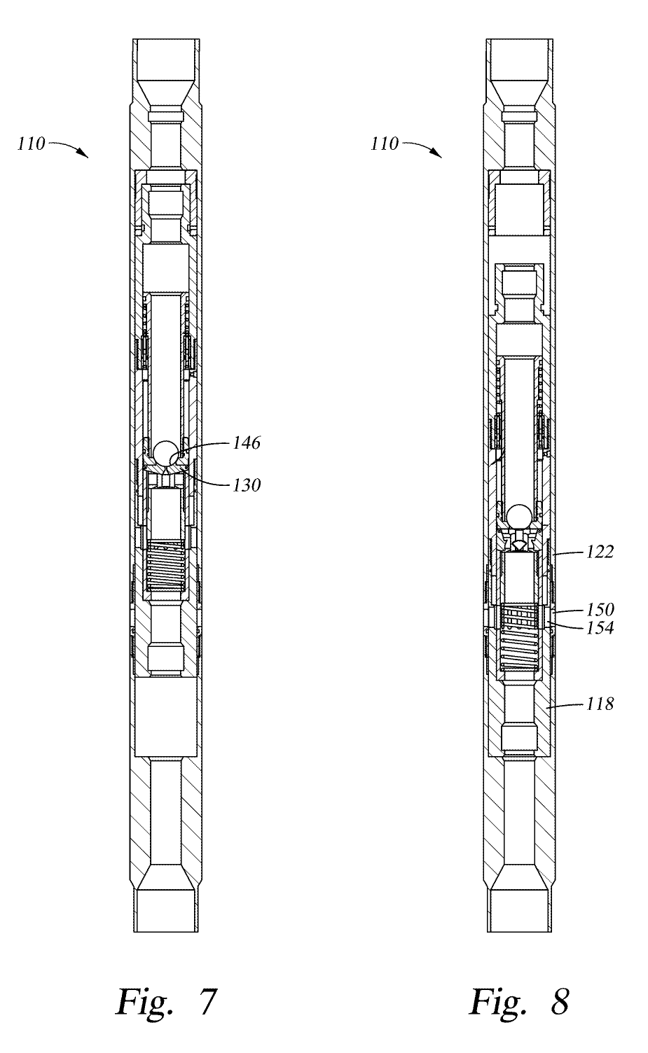

Referring to FIG. 6, the sleeve 134 as illustrated is in a fully stroked position. As such, ends 138 of seat 126 have contacted cams 142 on each of the support members 130 causing the support members 130 to rotate to the support position shown in FIG. 7 thereby presenting support surfaces 146 to the runnable member 128. Consequently, further increases in pressure against the engaged runnable member 128 will urge the body 118 to move relative to the tubular 122 (to the position shown in FIG. 8), instead of extruding the runnable member 128 past the restrictor 114. The foregoing structure allows an operator, by selectively controlling a pressure versus time profile, to selectively pass the runnable member 128 beyond the restrictor 114 or to selectively move the restrictor 114 to a supported position to thereby allow actuational movement of the body 118 relative to the tubular 122.

The actuator 110 is further configured to allow passage of the runnable member 128 even after the support members 130 have rotated and supported the runnable member 128. To do so requires the pressure against the runnable member 128 to be decreased to a level below a biasing force of the biasing member 56 that, as described with reference to FIG. 4, biases the sleeve 134 to return to its original position with respect to the body 118. Doing so in this embodiment positions the restrictor 114 in a position to be passable or actuatable through engagement with another of the runnable members 128.

The embodiment of FIGS. 5-9 is also configured to open ports 150 in the tubular 122 by aligning ports 154 in the body 118, thereby providing fluidic communication between an inside and an outside of the tubular 122. Such fluidic communication is useful for production of hydrocarbons, for example, in an application directed to hydrocarbon recovery. Additionally, such fluidic communication allows for fracturing of a downhole formation through pressurization of the formation through the open ports 150, 154.

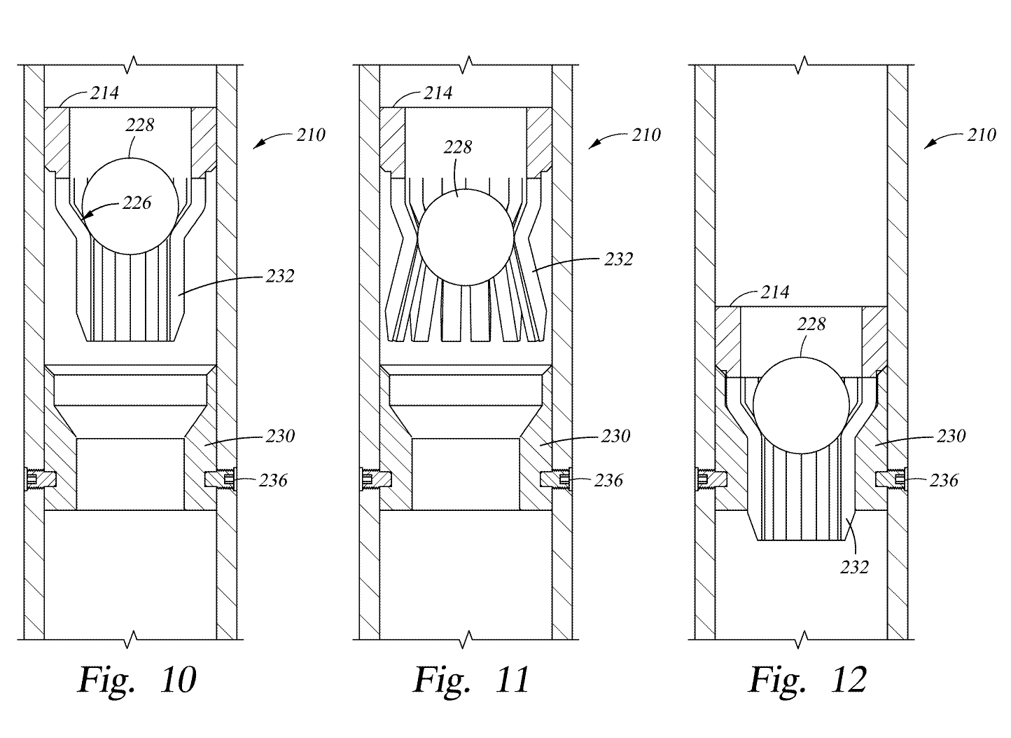

Referring to FIGS. 10-12, an alternate embodiment of a tubular actuator is illustrated generally at 210. The actuator 210 is similar to the actuator 110 in that a runnable member 228 is passable thereby in response to a threshold pressure being provided against the runnable member 228 prior to expiration of a time delay, and whereas, increases in pressure beyond the threshold pressure only after the time delay has expired will not result in passage of the runnable member 228 thereby. The actuator 210 differs from the actuator 110 in that the runnable member 228 does not deform and extrude through a restrictor 214, as does the runnable member 128 by the restrictor 114. Instead, a seat 226 of the restrictor 214 repositions, or deforms as is illustrated in this embodiment, to allow passage of the runnable member 228 (the runnable member 228 remaining in a nondeformed condition).

Structurally, the seat 226 of the restrictor 214 is cantilevered on fingers 232 that can flex radially outwardly when loads due to pressure exceeding a threshold pressure are applied against the runnable member 228. Additionally, the seat 226 can be mounted on a sleeve with fluidic chambers to control movement of the seat 226 relative to a tubular 222 as is done in the above embodiments, additionally, other means of damping movement can be employed. A support member 230 positioned downstream of the restrictor 214, as defined by the direction of pressure supplied against the runnable member 228, is configured to support the fingers 232 from outward radial expansion if the restrictor 214 moves into overlapping engagement with the support member 230 prior to passage of the runnable member 228 by the restrictor 214. Support of the fingers 232 by the support member 230 prevent radial outward deflection of the fingers 232 that is necessary to pass the runnable member 228 by the restrictor 214. As such, an operator can selectively pass the runnable member 228 by the restrictor 214 or have the runnable member 228 actuationally engage with the restrictor 214 by selectively controlling a pressure versus time profile of the pressure applied to the runnable member 228 once seated on the seat 226.

Actuation of the actuator 210 can be accomplished by pressuring up to pressure greater than the threshold pressure against the runnable member 228 seated against the seat 226 after the restrictor 214 has moved into supporting engagement with the support member 230. One or more releasable members 236, illustrated herein as shear screws, can releasable attach the actuator 210 to the tubular 222 until a sufficient load is applied to release the releasable members 236, thereby allowing the actuator 210 to actuate relative to the tubular 222.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A tubular actuator comprising:
a tubular;
a support member disposed at the tubular; and
a restrictor being configured to pass a runnable member when unsupported by the support member and to prevent passage of the runnable member when supported by the support member, the restrictor being movable relative to the support member from an unsupported position to a supported position in response to pressure being applied against the runnable member engaged with the restrictor according to a pressure versus time profile.

2. The tubular actuating of claim 2, wherein a pressure versus time profile including pressure remaining at or below a threshold pressure for a duration of time causes the restrictor to move to the supportive position.

3. The tubular actuating of claim 2, wherein the duration of time is selectable.

4. The tubular actuating of claim 2, wherein duration of time is defined by fluid flow through one or more ports.

5. The tubular actuating of claim 2, wherein the duration of time is controlled by damped movement of the restrictor relative to the support member.

6. The tubular actuating of claim 1, wherein the restrictor in the supportive position prevents extrusion of the runnable member thereby.

7. The tubular actuating of claim 1, wherein in the supportive position the support member prevents passage of members even smaller than the runnable member.

8. The tubular actuating of claim 1, wherein a pressure versus time profile including pressure exceeding a pressure threshold before expiration of a duration of time allows the runnable member to extrude past the restrictor.

9. The tubular actuating of claim 1, wherein a pressure versus time profile including pressure exceeding a pressure threshold before expiration of a duration of time allows the restrictor to expand thereby allowing passage of the runnable member.

10. The tubular actuating of claim 1, wherein the support member includes a plurality of movable members.

11. The tubular actuating of claim 10, wherein the plurality of movable members are cam actuated.

12. A method of selectively actuating a tubular actuator, comprising:
running a runnable member within a tubular;
engaging a restrictor disposed at the tubular with the runnable member; and one of
pressuring up against the engaged runnable member to pressure exceeding a threshold pressure before expiration of a selected period of time and passing the runnable member past the restrictor; or
pressuring up against the engaged runnable member to pressure equal to or less than the threshold pressure for at least the selected period of time thereby moving the restrictor to a supported position and preventing passage of the runnable member.

13. The method of selectively actuating a tubular actuator of claim 12, further comprising extruding the runnable member by the restrictor.

14. The method of selectively actuating a tubular actuator of claim 12, further comprising deforming the restrictor and passing the runnable member thereby.

15. The method of selectively actuating a tubular actuator of claim 12, wherein the moving the restrictor is in a downstream direction.

16. The method of selectively actuating a tubular actuator of claim 15, further comprising damping the moving of the restrictor.

17. The method of selectively actuating a tubular actuator of claim 16, further comprising defining the period of time with the damping of the moving of the restrictor.

18. The method of selectively actuating a tubular actuator of claim 16, wherein the damping the moving of the restrictor includes pumping fluid through one or more ports.

19. The method of selectively actuating a tubular actuator of claim 12, further comprising moving a support structure to a position more restrictive than the restrictor.

20. The method of selectively actuating a tubular actuator of claim 12, further comprising reducing pressure against the engaged runnable member and moving the restrictor to an unsupported position.

21. The method of selectively actuating a tubular actuator of claim 12, wherein the preventing passage of the runnable member is at pressures even greater than the threshold pressure.

22. A tubular actuator comprising a restrictor positionable within a tubular relative to a support member between an unsupported position where passage of a runnable member is facilitated, and a supported position where passage of the runnable member is prevented.

23. The tubular actuator of claim 22 wherein the position of the restrictor is dictated by pressure relative to a threshold of both pressure and time where the pressure is acting on the runnable member after engagement with the restrictor.
